(19) United States
(12) Patent Application Publication
(10) Pub. No.: US 2020/0045893 A1
(43) Pub. Date: Feb. 13, 2020

(54) PLANT NURSERY AND STORAGE SYSTEM FOR USE IN THE GROWTH OF FIELD-READY PLANTS

(71) Applicant: Rodney Sidloski, Weyburn (CA)

(72) Inventor: Rodney Sidloski, Weyburn (CA)

(21) Appl. No.: 16/655,838

(22) Filed: Oct. 17, 2019

Related U.S. Application Data
(62) Division of application No. 15/258,219, filed on Sep. 7, 2016.

(51) Int. Cl. A01G 9/029; A01G 27/02

(52) U.S. Cl. CPC A01G 9/0295; A01G 27/02

(57) ABSTRACT

A plant nursery and storage system for use in the growth and storage of field-ready plants. At least one planting block with tapered planting cells therein and extending openly from the top surface to the bottom surface thereof is placed in a container holding water. Plant material placed in the planting cells, with or without planting media, will grow into field-ready plants. The growing plants will be sub-irrigated by accessing water through the open base of the planting cells contacting the water in the container. The sub-irrigation technique of the invention replaces industry standards of top irrigation and bottom aeration for plant production, and addresses high costs associated with current production methods in the production of field-ready trees, shrubs, forbs, perennials, vegetables and grasses.

### CROSS-REFERENCE TO RELATED APPLICATIONS

This is a Divisional application claiming priority to U.S. patent application Ser. No. 15/258,219 filed on Sep. 7, 2016, the contents of which is hereby incorporated by reference in the entirety.

### FIELD OF THE INVENTION

This invention is in the field of indoor and outdoor plant production, and more specifically discloses a novel system and method for the growth of field ready plants from plant material using a novel sub-irrigation method.

### BACKGROUND

Western countries suffer high capital infrastructure and high labour costs in indoor tree production and horticulture production due in part to requiring specialized highly trained personnel to operate complex nursery equipment and processes. Tree production operations in southern hemisphere countries typically suffer from extremely high labour requirements, large land spaces for nurseries and very high soil requirements and high transport costs. Cost of labour, machinery and chemical associated with mechanized and manual cultivation and herbicide and fertilizer application in conventional bare root tree seedling field nurseries and for vegetable seedling and food production is a significant cost. If these costs could be reduced or eliminated then the cost of tree production would likewise be greatly reduced.

Container plant production systems in countries with sub-zero climates require costly greenhouse buildings and irrigation/water quality control technology, nutrient control and often PH balancing processes, and sometimes hydroponic infrastructure. In the case of outdoor field nurseries, costly irrigation, and intensive machinery and/or labour for weeding and cultivation or costly mulching to achieve the same end is required. Conventional outdoor nurseries require significant land space that is costly and more so when outdoor nurseries are in the vicinity of urban centers where real estate values are higher. Container plant production methods that relied upon the highest planting density possible to minimize land and requirements and cost and equipment necessities would be positively accepted in industry.

Vast amounts of global forests have been cut down for farmland expansion, timber industry or consumed for fuel, and reforestation programs are significantly limited by the high cost of tree production. Methods of producing high volumes of seedlings for the reseeding of forests and other consumed crops and natural resources at the lowest possible cost would be a desirable outcome. Many Asian countries are now in a panic to reforest ocean margins to protect against extreme ocean events. However they lack upscale tree production capability to meet the need. In some Asian countries such as Malaysia, tree availability is so scarce that government often acquires trees for reforestation by hiring personnel to dig up seedlings one by one from the forest for this purpose.

The harsh and sometimes highly variable climate of northern latitude countries such as Canada, the northern U.S. and many parts of Europe have prompted many tree production centers to build costly indoor green houses and supporting technologies to start tree seedlings in the winter months for marketing and distribution in the spring and summer period. While some of these nurseries run year-round, others close down for the winter months due to high cost of maintaining plants indoors during the harshest winter months. These and even year round indoor nurseries often dispose of excess container plants due to the high cost of year round maintenance or due to lack of space for new greenhouse crops.

Efforts to minimize the cost of labour often involve high cost capital acquisition of computerized watering and shading systems, water purification, nutrient feeding and PH balancing operations. Examples of complex nursery systems can be seen in Canadian patents 2216735 (Takayuanagi), 1122803 (Da Vitoria lobo), 2119043 (Ynohara), and 2382585 (Hessel & Bar-On). In Patent 1122803, Da Vitoria Lobo uses an advanced hydroponics method, but it requires an intensive amount of machinery and micromanagement in addition to the requirement of highly skilled operators. Hessel and Bar-On take this a step further, almost completely automating plant production with robotics. This requires significant capital as well as considerable infrastructure. Container rooted trees, also known as tree plugs use polystyrene blocks, commonly used in the industry as outlined in Canadian patent 2328151 (Pelton), have been primarily used in indoor nurseries using overhead irrigation with water draining capability out the bottom of the polystyrene blocks. While the polystyrene block system utilized indoors can create savings in labour and space relative to conventional field nurseries, the building and technology involved in this practice are extremely expensive relative to the almost zero infrastructure requirements of outdoor nurseries using the bagged tree system in southern continents. If it were possible to come up with an alternate plant nursery system and method to allow for economical production of field ready plants from plant material, it is believed that this would be widely commercially accepted.

One of the key concepts which it is believed could provide economic efficiency in container plant production of field ready plants would be to find an alternate method of irrigation, rather than top-down irrigation into the containers in which plant material is planted. Top-down irrigation requires significant labour, or technology in its place, and results in a reasonable amount of water wastage as well. If there were a way to eliminate or minimize labour or technology costs and minimize water waste this would be widely commercially accepted in the commercial nursery business. The concept which the inventor has chosen as an alternate approach of irrigation of container gardened plants is to sub-irrigate them, rather than irrigating them from the top down. Passive sub-irrigation will result in the minimization of water waste and labour.

Even in the field of sub-irrigation past attempts in the prior art involved significant investments in technology and in our view overly complicated methodology. For example, Canadian patent 24448782 (Rejean) describes a Hydroponic Growing Unit in which water is supplied to a growing unit in which “water is pumped from the base to the top of each block . . . ”. However, that system involves a relatively complex planting block that is enclosed in a complex structure.

Tree seedlings grown in most large scale tree nurseries in cold climate countries with defined seasons have a limited shelf life. That is, most large scale tree production nurseries cater exclusively to the traditional spring and summer planting season after which they discard for composting unsold seedling stock. The trees are discarded, sometimes in the tens of thousands, in part because the nursery's expensive greenhouses have no space for new tree crops in their high cost buildings if the old crops were kept. Solutions are required that create low-cost live tree storage so that end of season tree seedlings do not have to be discarded but kept to be sold in subsequent seasons sometimes as extra value larger tree stock for additional marketing opportunities. At a time when access to low cost trees is at its most critical, some would suggest it wise to create a low cost means of preserving end of season tree stock.

### SUMMARY OF THE INVENTION

As outlined above, the invention is a sub-irrigation plant nursery and storage system, for use in the growth of field ready plants, and a method of growing field ready plants using such a system, which represents an advantage over many aspects of current practices and prior art approaches.

In a first embodiment, the invention comprises a sub-irrigation plant nursery and storage system for use in the growth of field ready plants which comprises two key components. The first key component of the sub-irrigation plant nursery and storage system is a container holding water, and the second component is at least one planting block within the container, each planting block having a top surface and a bottom surface and a plurality of planting cells extending therethrough from the top surface to the bottom surface, wherein each planting cell is tapered from the top aperture at the top surface to a bottom aperture on the bottom surface so that the top aperture of each planting cell is larger than the bottom aperture thereof. The number of planting blocks can be one or it could be more than one, as will be understood in the context of the remainder of the disclosure outlined herein.

The at least one planting block is positioned in the container such that the bottom surface thereof is in contact with water in the container, so that plants growing within the planting block are completely irrigated from the bottom surface of the block without the need for top irrigation—the root system of the plant material within the planting cells will access the water in the container through the bottom aperture of the planting cell. Plant growth material is placed within a planting cell to grow into at least one field ready plant with in the planting cell. The concept of sub-irrigation is used insofar as the only thing that needs to be done to water all of the plants within the system is to ensure the presence of a sufficient quantity of water within the container, which can be absorbed by the plant material and plants within the planting blocks via their bottom surfaces which are immersed in or floating on the water within the container.

As outlined above, the sub-irrigation plant nursery and storage system might consist of a single planting block within a container, or there may be more than one planting block used in a single water container without departing from the scope and intention of the present invention. In fact it is contemplated that the most desirable embodiments of the system of the present invention will include a plurality of planting blocks, since large quantities of plant material can be grown into large quantities of field ready plants by the use of more than one planting block in a water container.

At least one planting block may be made of a non-buoyant material i.e. such that it would sit on the bottom of the water container with the bottom surface thereof in contact or in proximity to the interior surface of the water container. In such a case, the bottom aperture of the planting cells would still permit access of water into the planting cells to provide some irrigation to the plant material contained therein. Alternatively at least one planting block might be made of buoyant material such that the planting block would float on or in the water contained within the container. Both buoyant and non-buoyant planting blocks are contemplated within the scope of the present invention.

Where at least one planting block is made of a non-buoyant material, it may be desired to suspend the non-buoyant planting block or planting blocks within the container by at least one block support, such that they were suspended above the interior surface of the water container and allow for easier access of water to the bottom of the planting cells extending therethrough. The at least one block support might consist of legs or similar structure placed beneath the at least one non-buoyant planting block, or in other embodiments might consist of a plurality of ropes or similar rods or extensions across the top of the water container which engaged the non-buoyant planting blocks in a way to hold them in position above the bottom of the interior of the water container.

Where the at least one planting block is made of a buoyant material it can float in the water within the container. In some instances, at least one buoyant planting block might, in addition to the planting cells therethrough, further comprise additional holes within or through the planting block. These holes might be present in the planting block to alter the buoyancy of the article, or for other unrelated purpose.

The at least one planting block of the system of the present invention could be many different shapes in terms of the top and bottom surface thereof. From the perspective of time and packing as many planting blocks as possible into the container, it is explicitly contemplated that the sub-irrigation plant nursery and storage system might use at least one planting block that has a rectangular top surface—with the planting cells would likely be arranged in a linear grid pattern thereon. Other top surface shapes and placement patterns or matrices for the planting cells within the at least one planting block can also be used and any such arrangement will be understood to be contemplated within the scope of the present invention.

In the use of the sub-irrigation plant nursery and storage system, plant growth material can be placed within a planting cell without planting medium, such that at least one field ready plant which grows therefrom grows in air within the planting cell, without growing media. Alternatively in other instances, where it is desired to grow the field ready plants within the planting cells of at least one planting block within a growth media such as soil or the like, and plant growth material would be placed in a planting cell along with such planting media. The growth of plant growth material and field ready plants either in planting media such as soil, or in air, are both approaches which are contemplated within the scope of the present invention.

It will be understood to those skilled in the art that the at least one planting block can have varying dimensions as to the planting cells. The at least one planting block, if traditional planting block material is used might be a block of a thickness between 2 inches and 9 inches, although it will be understood that any different type of material and dimensions could be used without departing from the scope of the present invention. Similarly, planting cells could be of varying sizes in a planting block depending on the nature of the finished plants it was desired to produce—the planting cells could for example have a volume in the range of 8 mL to 3200 mL, or any other size depending upon the desired outcome and all such sizes and dimensions will again be understood to be contemplated within the scope of the present invention.

Planting blocks of different material or different characteristics and dimensions can all be used within the same water container without departing from the scope of the present invention as well. For example buoyant and non-buoyant planting blocks can be used, planting blocks with cells of more than one size could be used or any number of other different parameters can be varied without departing from the scope of the present invention.

The container of the sub-irrigation plant nursery and storage system is a container capable of holding water and retaining the at least one planting block therein. It might consist of purpose built or a natural in-ground water reservoir, or in other implementations it could be an above ground or in-ground manufactured container. If it is a manufactured container, that might be portable or permanently installed.

One or more field ready plants can be grown in a single planting cell of a single planting block in accordance with the remainder of the system and method of the present invention, depending upon the desired outcome and the nature of plant material placed in a cell. Plant material placed in the growth cells of the planting blocks of the present invention would be selected from at least the group of trees, shrubs, forbs, perennials, vegetables and grasses. Really any type of a plant which it is desired to produce for a field ready planting status and which can be grown from initial plant material could be produced using the system of present invention provide that proper plant material was available.

Once the field ready plants are grown within the planting cells on a planting block in accordance with the remainder of the sub-irrigation plant nursery and storage system of the present invention, the field ready plants can be stored within their respective cells in a planting block until they are ready to be deployed for field planting. The planting block can simply be stored in water within the water container until the transplanting of plants to the field is desired.

It will be understood that many variations on the sub-irrigation plant nursery and storage system of the present invention will be clear to those skilled in the art of horticulture, agriculture and similar product design and all such obvious modifications and enhancements are contemplated to be within the scope of the claims in the present invention.

In addition to a sub-irrigation plant nursery and storage system, the present invention also comprises a method of growing field ready plants. The method comprises providing a sub-irrigation plant nursery and storage system which comprises a container capable of holding water and at least one planting block placed in the container and having a top surface and a bottom surface and a plurality of planting cells extending therethrough from the top surface to the bottom surface. Each planting cell is tapered from the top aperture on the top surface of the block to the bottom aperture on the bottom surface of the block with the top aperture of the planting cell being larger than the bottom aperture thereof for the purpose of making it easier to retain plant growth media within the planting cell that is desired to be used. The system provided would include the at least one planting block being in contact with water in the container via the bottom surface, so the plants growing within the planting block are completely irrigated from the bottom surface of the block and without the need for top irrigation. Plant growth material placed within a planting cell would grow into at least one field ready plant as desired within the planting cell and accesses water in the container through the bottom aperture of its planting cell.

Using the provided system, the method comprises a planting step in which plant growth material is placed within planting cells in the at least one planting block, followed by a sub-irrigation step which comprises ensuring the placement and maintenance of water within the container such that plant growth material within planting cells in the at least one planting block can access water through the bottom aperture of planting cells. The water level would be monitored and maintained within the container until feel gritty plants are ready to be harvested from the planting cells. This simple method of planting and growth of field ready plants from plant material, using a sub-irrigation method, represents a significant enhancement over the current state-of-the-art in this area both in terms of simplicity of equipment and methods employment as well as the overall cost of production of the field right plants in question.

As outlined about with respect to the system of the present invention, the method might use a system which had at least one non-buoyant or at least one buoyant planting block within the water container. The non-buoyant planting blocks could potentially sit on the bottom surface interior of the container and access by osmosis water through their bottom edges of the planting cells therein, or could be suspended above the bottom surface of the container using one or more planting block supports. Where the planting block is buoyant it could float in the water within the container.

Field ready plants can be grown in planting blocks and their planting cells in accordance with the method of the present invention with or without planting medium such as soil within the planting cells. It is explicitly contemplated that the method could grow field ready plants in air within the planting cells, or within soil or growing media.

The method could use planting blocks which have planting cells of more than one size in a particular planting block. One or more planting blocks can be used in the container of the system which is used in the method of the present invention and in fact is contemplated that the best embodiments would comprise a plurality of planting blocks allowing for dense growth of large quantities of field ready plants in the smallest possible water container space.

The method could either use an in-ground water reservoir as the water container, or a manufactured container on or in the ground surface can be used.

The method of the present invention can be used to grow field ready plants from plant material selected from the group of trees, shrubs, forbs, perennials, vegetables and grasses.

One or more field ready plants can be grown within a plant cell. Nutritional supplements may or may not be provided to plants within the planting cells beyond those contained in the water. Nutritional supplements can be provided to field ready plants or plant material within the planting cells either by addition of the nutritional supplements to the water within the container, or by application of the nutritional supplements over the top surface of the planting block.

As outlined above, the system and method of the present invention provides for many different embodiments and variance on the core method and approach, of growing field ready plants from plant material in at least one planting block within a water container which allows for the plants growing within the planting cells of the planting block to access water for irrigation purposes using a sub-irrigation method, via bottom apertures in the planting cells therein. Many embodiments of the invention could be envisioned as modest enhancements or changes to the underlying method without departing from the scope and intent hereof and it will be understood that all such changes are intended within the scope of the present invention by the inventor.

A sub-irrigation nursery disclosed herein is a low cost indoor or outdoor method of culturing, growing and maintaining container root plants and providing long term live storage of these plants until they are required for sale or use. The innovation utilizes either buoyant or non-buoyant planting blocks—including industry standard polystyrene planting blocks—filled with typical nursery sound mixes to set irrigate plants growing therein. This replaces the industry standard of top irrigation and bottom aeration per planting blocks, for a wide range of plants.

### DESCRIPTION OF THE DRAWINGS

To easily identify the discussion of any particular element or act, the most significant digit or digits in a reference number refer to the figure number in which that element is first introduced:

FIG. 1 is a flowchart demonstrating the steps involved in one embodiment of the method of the present invention;

FIG. 2 is a flowchart demonstrating the steps involved in an alternate embodiment of the method of the present invention;

FIG. 3 is a perspective view of one embodiment of the system of the present invention, in which the container is a small scale surface container holding a single planting block;

FIG. 4 is a perspective view of one embodiment of a planting block in accordance with the present invention;

FIG. 5 is a partial cross-sectional view of the planting block of FIG. 1, demonstrating the tapered shape of the planting cells therein;

FIG. 6 is a perspective view of another embodiment of the system of the present invention, in which the container is a manufactured large scale water pan;

FIG. 7 is a perspective view of another embodiment of the system of the present invention, in which the container is a manufactured water pan with planting blocks deployed in a high density lane system therein;

FIG. 8 is a perspective view of another embodiment of the system of the present invention in which the container comprises a series of continuous semi-independent segments of sub-irrigation trough of any length that can be used on the level or downslope in a manner that the entire series of segments can be filled with water from one end even if the series of trough segments is on tending down a slope;

FIG. 9 is a top view of the embodiment of FIG. 8; and

FIG. 10 is a perspective view of another embodiment of the system of the present invention, in which the container is a natural pond.

### DETAILED DESCRIPTION OF ILLUSTRATED EMBODIMENTS

As outlined above, the general concept of the present invention is a sub-irrigation nursery system for use in the expedited and low cost production of field ready plants from planting material. Input costs and labour costs for irrigation and periodic attendance on the plants during the growth timeframe is minimized using the system and method outlined herein. It will be obvious to those skilled in the art reviewing this document that there are certain enhancements or modifications that could be made to certain elements of the method without departing from the scope of the intended coverage of this document and all such modifications as would be obvious to one skilled in the art are contemplated within the scope of the present invention.

Method Overview:

As outlined

, the present invention consists of a system and method for the growth of field ready plants from plant material in a sub-irrigation nursery and storage system. Many different types of plants which are ready for field plant can be grown in accordance with the system and method outlined herein. The general concept of sub-irrigation of containerized plant growth material be used to produce field ready plants is a distinct and enhanced method over top irrigation methods currently used in the prior art.

The first step in the method of the present invention is the provision of a sub-irrigation plant nursery and storage system which comprises a container capable of holding water, and at least one planting block placed within the container and having a top surface and a bottom surface and a plurality of planting cells extending therethrough from the top surface to the bottom surface, wherein each planting cell is tapered from the top aperture on the top surface to the bottom apertures on the bottom surface, the top aperture of the planting so being larger than the bottom aperture thereof. The bottom surface of the at least one planting block is capable of contact with water within the container, such that plants growing within the planting block are completely irrigated from the bottom surface of the block and without the need for top irrigation. Plant growth material placed within a planting cell grows into at least one field ready plants within planting cell and accesses water in the container through the bottom aperture of the planting cell.

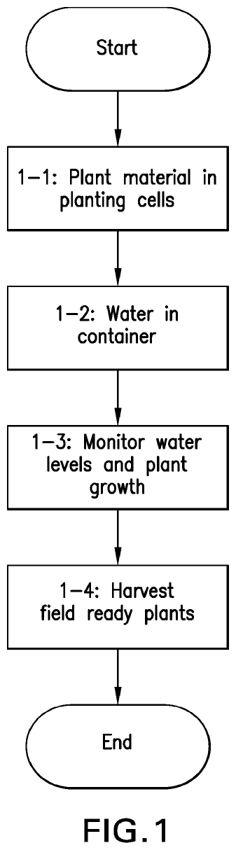

Using this system, the physical steps of the method of plant production in accordance with the invention outlined herein can now be discussed in further detail. We refer first to FIG. 1 which is a flow chart demonstrating the steps involved in a first embodiment of the method of the present invention. Shown at 1-1, plant growth material is placed within the planting cells in the at least one planting block, in a planting step. Following the planting step, in a sub-irrigation step water is placed within the container, such that plant growth material within the planting cells in the planting blocks can access the water through the bottom aperture of the planting cells. This step is shown at 1-2.

Once water is placed in the container, the water level within the container can be monitored and maintained until field ready plants are ready to be harvested from the planting cells. The monitoring and maintenance of the water level within the container is shown in step 1-3 in this flowchart. Once field ready plants are present in one or more of the planting cells in the at least one planting blocks, they can be harvested at the appropriate time by simply removing said field ready plants or plants potentially with a soil or growing media all around their roots, from the respective planting cells—new plant growing material can be planted in the planting cells and further field ready plants prepared. Harvesting of the completed field ready plants and shown at step 1-4.

Labour and maintenance cost of the system used in this method is significantly minimized over prior art approaches, since all that needs to be done to irrigate all of the plants that are growing in the planting cells of the at least one planting block within the container is to simply ensure that there is enough water present within the container. Individual plants need not be watered as they passively obtain water through the sub-irrigation method.

The sub-irrigation plant nursery and storage system which is used in the method of the present invention could be the system of any embodiment demonstrated or enabled, and discussed in further detail below. For example, at least one planting block used within the container could be made of a non-buoyant material, and at least one planting block could be made of a buoyant material. In certain embodiments of the system used in the method, both buoyant and non-buoyant planting blocks could be used within the same container and system and all such approaches are contemplated within the scope of the invention as outlined herein.

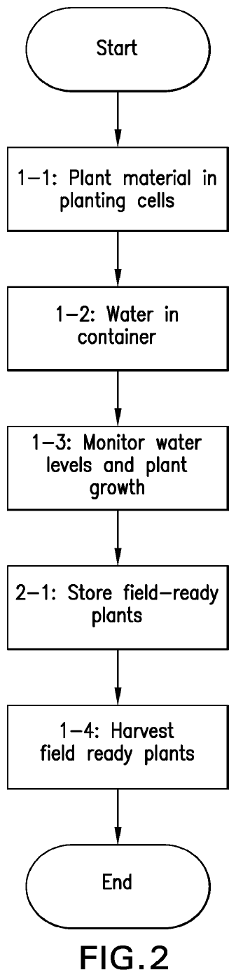

Beyond providing an ability for the sub-irrigation of plant growing material to grow field ready plants, as is also outlined and enabled herein, the system and method of the present invention allows for the storage of the grown field ready plants until they are ready to be deployed, sold or used. The field ready plants can be stored in a live format, by simply leaving them in their respective planting cells in the planting blocks in question and continuing to maintain the water level within the container. Referring to the flowchart of FIG. 2 there is shown a flowchart of an alternate method in accordance with the present invention, wherein the basic steps of the plant growth method as shown in FIG. 1 are shown, but a storage step with respect to the field ready classes shown at step 2-1, where the grown field ready plants are stored within their planting cells in the planting blocks until they are required for use. It will be understood that there are modifications which could be made to the overall method disclosed, none of which will depart from the obvious and intended scope of the invention disclosure contained herein and all such modifications to the method or system of the present invention are intended to be considered within the scope hereof.

There are many variations on the method which are contemplated—for example in addition to the possibility that both buoyant and non-buoyant planting blocks could be used in a single system in accordance with the method of the present invention will also be understood that in some cases plant growth material which is placed in a planting cell would be placed in the planting cell along with planting media. The planting media could be soil or some other type of a nursery mix as would be known to those skilled in the art of greenhouse plant production and all such modifications or enhancements are contemplated within the scope of the present invention. It will be also understood that in certain cases, plant growing material could be placed within planting cells without any growing media and effectively grown in air. The growth of field ready plants either with or without growing media, or in some cases with some plant material being placed in planting cells in a planting block with growing media and others without, are all approaches which are contemplated within the scope of the present invention.

It will also be understood that one or more field ready plants could be grown within a single planting cell in a planting block, depend upon the nature or type of the plant, the size of the planting cell etc. Again all such approaches and modifications as will be understood to those skilled in the art of plant production are contemplated within the scope hereof.

Having reviewed the method of the present invention in detail as to its steps and execution, we will now review the actual sub-irrigation nursery and storage system and its components in further detail.

Sub-irrigation Nursery System:

The sub-irrigation plant nursery and storage system of the present invention comprises two key components. The first key component of the system is a container capable of holding water. The container could either be an inground water container reservoir, or a manufactured container which could be on or in the ground surface. In the case of an inground water container the ground water container which could be used might actually be a pre-existing or manufactured to purpose water pond or ground reservoir, or else an inground reservoir with walls such as a pool or the like could also be used.

Any container capable of holding water during the irrigation and plant production method of the present invention, and holding the at least one planting block as outlined in further detail herein, is contemplated within the scope of the present invention.

The second component of the system of the present invention is at least one planting block which can be placed within the water holding container. The at least one planting block will each have a top surface of the bottom surface with a plurality of planting cells extending therethrough, from the top surface to the bottom surface. Planting cells are tapered from a wider top aperture at the top surface to a narrower bottom aperture at the bottom surface. Plants growing within the planting cells can access water within the container via the bottom aperture of their planting cell.

The most likely embodiments of the system of the present invention would comprise a plurality of planting blocks used within a larger water holding container. Planting blocks might be held in place in vertical relation to the bottom surface of the container and within the water in the container, or in relation to the entire container capacity, by supports, guides or the like. The addition of such supports or guides to hold the planting blocks in place either within the larger water holding container, to hold them in position in relation to the walls of the container, or to hold one or more of the planting blocks in a particular vertical position above the bottom of the container so that water access to the bottom apertures of the planting cells was enhanced, are all contemplated within the scope hereof.

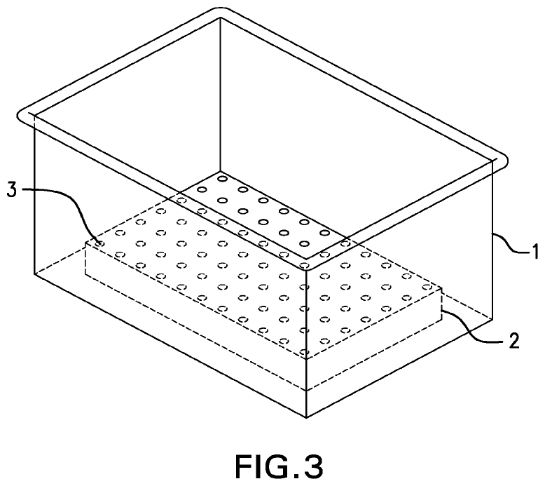

FIG. 3 shows one basic embodiment of the sub-irrigation plant nursery and storage system of the present invention. There is shown a container 1 which can hold water, with one planting block 2 therein. Planting block 2 includes a rectilinear grid pattern planting cells 3 thereon. If the planting block 2 was buoyant, as water was placed in the container 1 planting block 2 would float on top of or near the surface of the water. Alternatively, if the planting block 2 was not buoyant it may stay near the bottom surface of the container 1 and water placed in the container would need to access the bottom apertures of the planting cells 3 by osmosis under the outer edges of the planting block 2, or the planting block may also be manufactured in such a way that channels would be allowed for the flow of water thereunder.

Water is placed in the container 1, once plant growing material is placed in the planting cells 3. The plant growing material or plants growing within the planting cells 3 access the water in the container 1 through the bottom apertures of their respective planting cells. Water is maintained within the container 1. Individual plants need not be watered. Once the plants within the planting cells are field ready they can either be immediately removed for planting or deployment, or they can be stored indefinitely within the planting blocks, so long as they do not outgrow the planting cells, so long as water is maintained within the container 1.

The system of the present invention will allow for the densification of the production of field ready plants in reasonably compact land footprints. Labour cost is minimized during plant production, since the only irrigation labour which is required is to intermittently top up the water level within the container rather than needing to water individual plants in planting cells in the planting blocks in question.

Planting Block:

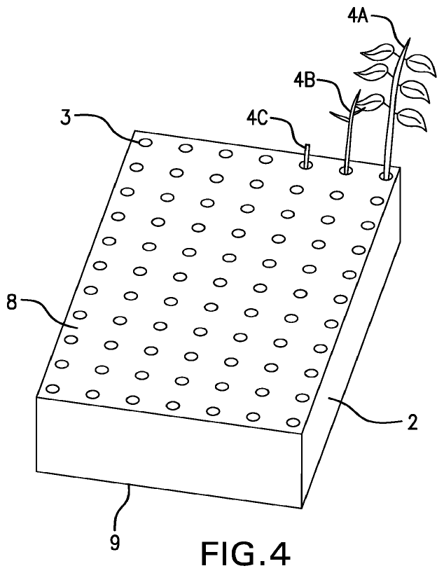

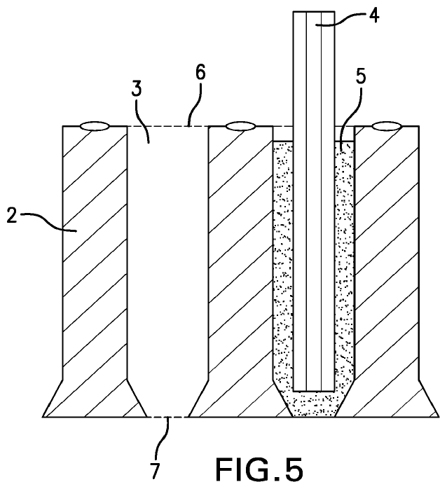

FIGS. 4 and 5 demonstrate one embodiment of the planting block in accordance with the present invention. The planting block 2 is contemplated to be any type of a block of material which planting cells 3 can be made or machined in accordance with the remainder of the design. As outlined elsewhere herein, the planting block 2 could either be a buoyant material which would float in the water within the container 1 of the system, or alternatively the planting block 2 could be a non-buoyant material.

For the purpose of the description of many of the other parameters of the planting block 2, the top surface 8 and the bottom surface 9 of the planting block 2 are also marked in this Figure.

As outlined throughout this document, the planting block 2 contains a plurality of planting cells 3. The planting cells 3 are each an aperture extending through the planting block 2, from the top surface 8 to the bottom surface 9, within which field ready plants can be grown. Each planting cell 3 consists of an approximately tubular aperture, with a larger top aperture that a bottom aperture, resulting in a narrowing taper from the top surface 8 to the bottom surface 9. The planting cells 3 as are shown in this Figure are arranged in a grid pattern allowing for the dance planting of a large number of quantities of plant growing material in the planting block 2, for the dance production of a large number of field ready plants therein.

Shown in the planting block 2 of this figure are also three plants, at various stages of growth, in three of the planting cells 3. These plants are shown at 4A, 4B and 4C, from smallest to most complete growth.

Referring to FIG. 5 there is shown a cutaway detail of two planting cells 3 within the planting block 2 as shown in FIG. 4. The planting cells 3 are shown. The top aperture 6 is shown along with the bottom aperture 7, demonstrating the narrowing taper of the planting cell 3. Also shown is a plant 4, growing within growing media 5 within the other planting cell 3 shown in this Figure.

As outlined elsewhere herein, the planting block 2 could be buoyant in which case it would float in the water within a container of the system of the present invention, or could also be non-buoyant. In the case of a non-buoyant planting block 2 it may be desired to place a frame or support of some kind beneath the non-buoyant planting block to elevate it above the lower surface and interior of the container to allow for easier access of water from the container to the bottom apertures of the planting cells therein. Alternatively the water may be simply like to see or creep under the outer edges of the bottom surface 9 of the planting block in a non-buoyant arrangement.

Where the planting block 2 was buoyant it would float in the water within a container in accordance with the system of the present invention. Both buoyant and non-buoyant planting blocks 2 are contemplated within the scope of the present invention.

The planting block 2 could be of many shapes and sizes. Most of the planting blocks 2 which are shown in the Figures and which are anticipated would be used would likely be rectangular in shape, on the top surface, since rectangular or at least rectilinear shaped planting blocks would be the easiest shape to use the most dense population of planting blocks within a container in the system of the present invention. However, beyond the rectangular planting blocks which are shown really any shape of planting block could be used. More than one shape of planting block could also be used in one system of the present invention.

In addition to the outer circumference or shape of the planting block, the planting block could be of varying thicknesses. The thickness of the planting block would be dictated primarily by the type of field ready plants which it was desired to grow in accordance with that particular planting block in the system. For example, smaller plants grown from smaller samples of plant growth material could be grown in a thinner planting block which would mean that the planting cells themselves would be shallower. As in the case of planting blocks of various shapes, planting blocks of varying thicknesses could be used in the system of the present invention where more than one planting block was used. It is specifically contemplated that at least one planting block in the system might have a thickness between 2 inches and 9 inches although it will be understood dependent upon the type of plant material being used or the field-ready plants it is sought to produce that thicknesses even outside of this range could also be used without departing from the scope and intention of the present invention.

In addition to the overall shape, and the thickness, there are other parameters of the at least one planting block which should also be varied dependent upon the use or desired outcome with the system and method of the present invention. For example, the planting cells could be of varying diameters. Planting cells within even a single planting block will be of the same diameter and shape, or they could vary such that there were some smaller and some larger planting cells within a particular planting block. In addition to the diameter or as a result of the diameter of round planting cells—there could also be planting cells in a particular planting block which are not round that were desired so long as the taper from the top to the bottom was achieved—the volume of the planting cells could vary depending upon the amount of growing media that it was desired to place into a cell, the size of the plant growth material which will be used to start the field ready plants produced, or the size of the root ball it is desired to accommodate within the planting cell once the field ready plant is completed. In the most desirable currently conceived embodiments, planting cells would have a volume in the range of 8 mL to 3200 mL, although it will be understood that a planting cell with virtually any volume will be contemplated to be within the scope of the present invention and related the volume of the planting cell is primarily driven by the parameters of the growing operation it is desired to conduct within that particular planting block. Planting cells of more than one size or internal volume could be used in a single planting block if it were desired to provide the ability to grow multiple types of plants in a single planting block or for other purposes. It will be understood that either using a planting block that has consistent and identical planting cells throughout, or multiple sites planting cells, are both contemplated within the scope of the present invention.

In terms of the taper of the planting cells from the top surface to the bottom surface of the planting block, the inner walls of the planting cell could taper down consistently all the way from the top surface of the bottom surface, or as shown in the embodiment of FIG. 4 the taper could be introduced to restrict the bottom of the planting cell by simply placing a tapered closure towards the bottom surface. Any such approach, so long as it relies upon a larger top aperture than a bottom aperture to a planting cell is contemplated to be within the scope of the present invention.

As outlined herein, the planting cells could be aligned in any number of different types of brand are more organized patterns on the surface of at least one planting block. It is specifically contemplated that for the purpose of generating the capability for the most dense planting pattern, a linear grid pattern for the planting cells would be the likely best approach, but any type of the arrangement or pattern of the planting cells on the surface of the planting block will be understood to be within the scope of the present invention.

Conventional polystyrene planting blocks could be used within the system of the present invention, or a custom manufactured planting block can also be created for use in accordance with the system outlined herein. In addition to the system and the method outlined herein, it is also expressly contemplated that the at least one planting block itself, as described herein for use in the system and method is also a patentable and distinct freestanding aspect of the present invention.

Container:

The second key element of the system of the present invention is a container capable of holding water. The container capable of holding water will be used to define the location of the at least one planting block used in accordance with the system of the present invention as well as to provide a water reservoir into which the at least one planting block of the system can be placed and from which sub-irrigation can be achieved of the various plants being grown in planting cells, through their bottom apertures. In the simple single planting block embodiment of the system of the present invention shown in FIG. 3 a container 1 is shown. Any type of a container capable of retaining water for use in the remainder of the system and method of the present invention is contemplated to be within the scope of the present invention, including inground or naturally occurring containers, or alternatively manufactured containers.

A manufactured container might be manufactured by excavation, in the context of an inground water container reservoir, or might also be a container for placement on or within a ground surface—for example which could be assembled on site and be portable or permanently installed. Any type of a container which can hold a sufficient quantity of water in its base to allow for the sub-irrigation method of the present invention to function when at least one planting block in accordance with the remainder of the present invention is placed therein is contemplated within the scope hereof. The next series of Figures disclose a number of different embodiments of the system of the present invention which are now discussed in further detail.

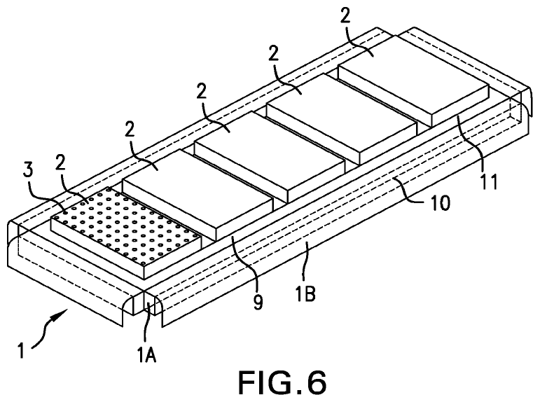

Referring to FIG. 6, the system is shown in which the container comprises a manufactured about ground container which is a larger scale water patent and the single block container shown in the embodiment of FIG. 3. The container 1 in this embodiment is an aboveground frame 1A with a waterproof liner 1B showing therein. Five planting blocks 2 are shown. Only the first planting block 2 has the planting cells 3 demonstrated therein, but as will be understood in accordance with the remainder of the specification, each of the planting blocks 2 would include a plurality of planting cells 3 therein in which field ready plants could be produced. The bottom surface 9 of the planting blocks 2 can also be seen, as is the bottom surface of the container 10. In this case, given the stationing of the bottom surface 9 of the planting blocks 2 above the bottom surface 10 of the container 1, it can be inferred from this Figure that the planting blocks 2 which are shown in this embodiment are buoyant, floating within the water 11 which is shown.

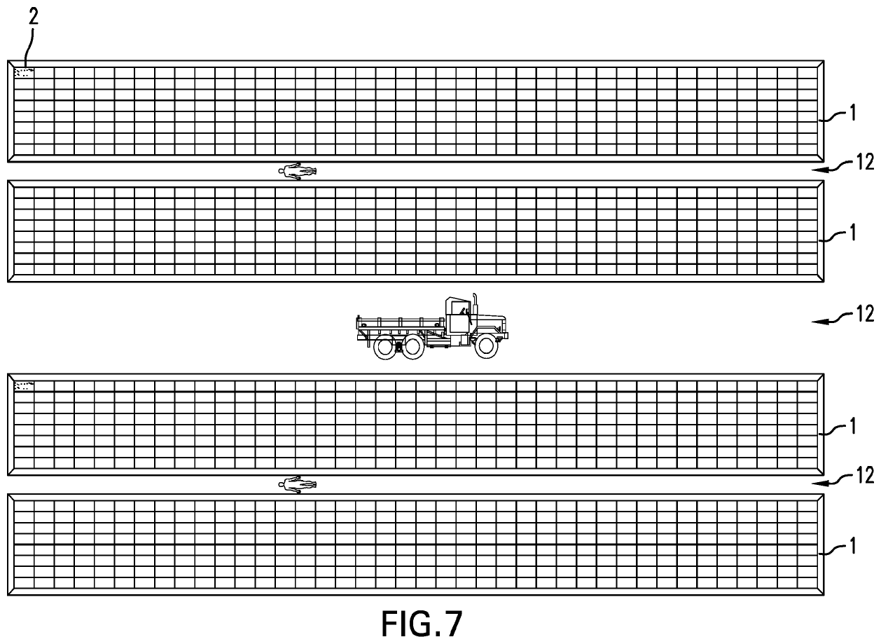

FIG. 7 shows another embodiment of the system of the present invention—in which actually four containers 1 are shown. The embodiment of the system shown in this Figure is intended to show a high density installation in which lanes for access are created between the containers.

Four containers 1 are shown, and in the first container 1 a sample of a planting block 2 with a plurality of planting cells therein is demonstrated. The grid patterns drawn on the containers 1 demonstrate all of the planting blocks 2 which could be placed in a single container 1. Given that they mention of the grid shown in each container 1 namely 40×8, 320 planting blocks 2 could be deployed in a single container 1 of this nature. The gridlines shown in the container 1 might also comprise ropes or other supports which could be used to retain the planting blocks 2 in question in their desired positions within the container 1.

While the system of the present invention eliminates the need for very much access by operators to individual planting blocks during the production cycle, the placement of lanes between containers of this size would enhance the ability to access the growth surface of the container as might be required. Three lanes 12 are shown, the centre one of which demonstrates a truck therein, and the top and bottom ones of which show an individual walking down the lane.

Each container 1 being waterproof in its interior, the only thing that needs to be done to irrigate all of the plants and all 320 planting blocks is to simply pour water into the container of a sufficient level to allow for the bottom apertures and bottom surfaces of the planting blocks 2 to access the water within the container 1.

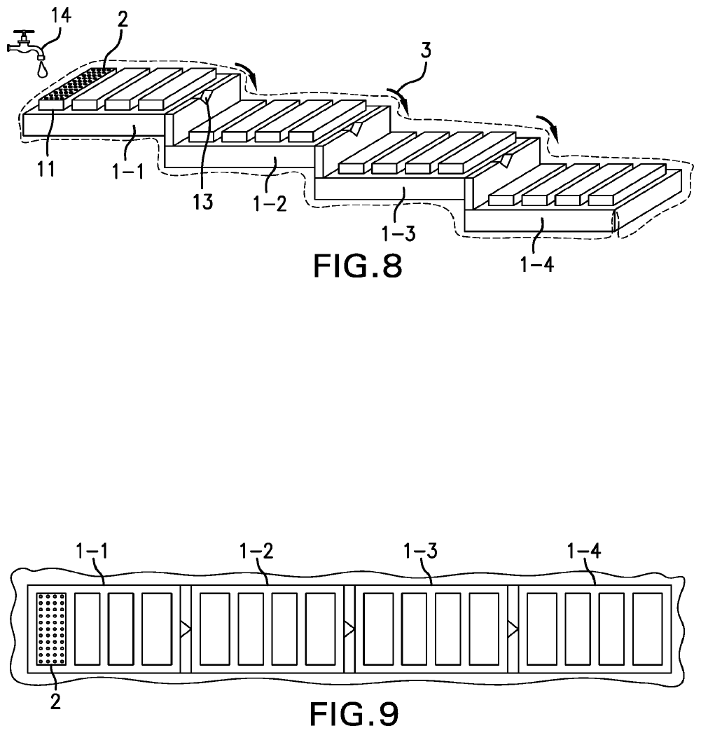

FIG. 8 demonstrates another embodiment of the system of the present invention in which the container 1 comprises four individual containers, or a four-part container, which can be used on a slope or terrace. It can be seen that a single water spigot 14 can be used to fill the water level you and in all four containers by simply pouring the water 11 into the top container 1-1 from where it can cascade down into the other three containers 1-2, 1-3 and 1-4. This further simplifies the process of filling the water 11 within the container 1 in accordance with the remainder of the method of the present invention.

Each of the four sub-containers shown in this Figure includes four planting blocks 2. The planting cells are again only diagrammed in the first planting block but it will be understood that there would be similar planting cells in each planting block 2. Similar to the embodiment of FIG. 7, the embodiment shown in this Figure could also be executed in a larger scale such that more than one row of planting blocks 2 or a longer row of planting blocks 2, could be deployed within a particular portion of the container 1.

FIG. 9 is a top view of the embodiment of the system of FIG. 8.

A system in accordance with the present invention could even in certain embodiments comprise a plurality of planting blocks positioned or restrained in position within a naturally occurring water reservoir or container. For example buoyant planting blocks could be deployed, in a grid or other pattern, within a naturally occurring water container such as a pond or the like, which would allow for one of the simplest deployments of a system in accordance with the method outlined herein. Even a naturally occurring or an excavated ground depression capable of holding a sufficient quantity of water for the sub-irrigation to be effective could be a desirable approach to be taken and the deployment of a plurality of planting blocks in accordance with the remainder of the present invention in this type of a naturally occurring or minimal requirements ground reservoir is explicitly contemplated to be within the intended scope of the system and the present invention outlined herein.

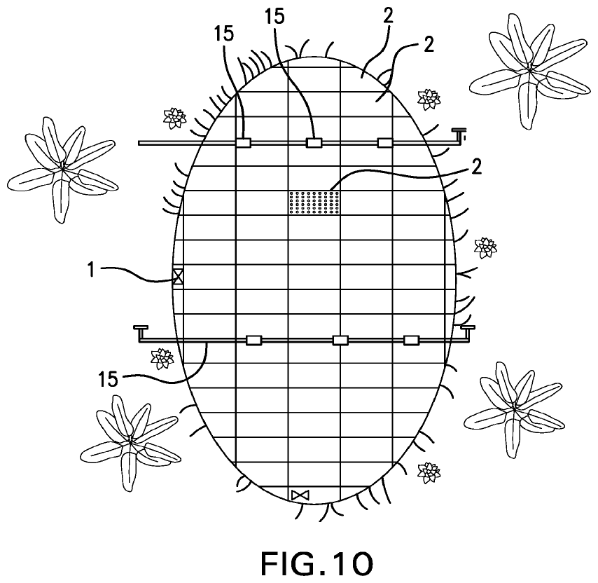

FIG. 10 demonstrates an embodiment of the system of the present invention such as this, in which the planting blocks 2 are deployed in a pattern within a container 1 which is a natural pond. The pond 1 is the container as outlined in the claims in the remainder of the description herein. A plurality of planting blocks 2 is shown on the surface of the pond 1. It is explicitly contemplated in the context of this type of container 1 that supports or ropes or the like would be used, regardless of whether the planting blocks 2 were buoyant or non-buoyant, to either replace or retain in position the planting blocks 2 on the surface of the container 1. In this case of plurality of ropes are contemplated to be used in conjunction with buoyant planting blocks. The ropes or supports 15 are shown in two horizontal positions across the pond container 1—the planting blocks 2 could simply be placed into the pond 1 such that they would float and be retained between those supports 15 in one direction. It is also possible that the gridlines down each side of each row of planting blocks 2 might also comprise additional ropes or supports 15 for the sake of retaining the planting blocks 2 even more closely in the desired position. Retention of the planting blocks 2 in only one direction by a unidirectional set of supports 15 is likely in most embodiments sufficient since beyond retaining the planting blocks 2 and general position, it likely is not necessary to maintain them in a precise floating pattern on the surface of the container 1.

It is explicitly contemplated that the deployment of the system and method of the present invention using a plurality of buoyant planting blocks within a natural pond or water body, retained in one or both directions on the surface of the water with the water body by one or more supports, comprises a complete system embodiment of the present invention which is patentable in accordance with the remainder of the disclosure herein.

Supports:

Supports could be used to support the at least one planting block in position within the container of the present invention. For example, if the at least one planting block was non-buoyant, it may be desired to provide a support that would support the at least one planting block above the bottom surface of the container to allow for easier access of water into the bottom apertures of planting cells therein. The supports could either consist of a frame or legs or the like placed below the planting blocks, or depending upon the nature of the container the supports for positioning the planting blocks within the container might also be frame members of the like which hung down or in proximity from the top of the container such that the planting blocks were defined in their positions by hanging down from this type of support rather than being supported from their base. Top-down supports such as this can also be used to define the position of buoyant planting blocks within the water container—for example defining ratings of planting blocks between which operator access to be insured or the like. The use of supports below the bottom surface of the planting blocks, or top-down “hanging” supports which either defined the vertical position of the planting blocks within the container or the positioning of the planting blocks in relation to others within the container are all contemplated within the scope hereof.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A sub-irrigation plant nursery and storage system for use in the growth of field-ready plants, the system comprising:
a. a container holding water; and
b. at least one planting block within the container, having a top surface and a bottom surface and a plurality of planting cells extending therethrough from the top surface to the bottom surface, wherein each planting cell is tapered from a top aperture on the top surface to a bottom aperture on the bottom surface, the top aperture of each planting cell being larger than the bottom aperture thereof;
wherein the at least one planting block is positioned in the container such that the bottom surface thereof is in contact with water in the container, such that plants growing within said planting block are completely irrigated from the bottom surface of the block and without the need for top irrigation; and
wherein plant growth material placed within a planting cell to grow into at least one field-ready plant within the planting cell accesses water in the container through the bottom aperture of the planting cell.

2. The sub-irrigation plant nursery and storage system of claim 1 wherein the number of planting blocks is one.

3. The sub-irrigation plant nursery and storage system of claim 1 wherein the number of planting blocks is more than one.

4. The sub-irrigation plant nursery and storage system of claim 1 wherein at least one planting block is made of a non-buoyant material.

5. The sub-irrigation plant nursery and storage system of claim 4 wherein the non-buoyant planting blocks are suspended within the container by at least one block support.

6. The sub-irrigation plant nursery and storage system of claim 1 wherein at least one planting block is made of a buoyant material and can float in the water within the container.

7. The sub-irrigation plant nursery and storage system of claim 6 wherein the at least one buoyant planting block further comprises additional holes within or through the planting block, in addition to the planting cells.

8. The sub-irrigation plant nursery and storage system of claim 1 wherein the at least one planting block has a rectangular top surface.

9. The sub-irrigation plant nursery and storage system of claim 1 wherein the planting cells arranged in a linear grid pattern on the top surface of at least one planting block.

10. The sub-irrigation plant nursery and storage system of claim 1 wherein plant growth material is placed within a planting cell without planting media, and the at least one field-ready plant growing therefrom grows in the planting cell in air, without growing media.

11. The sub-irrigation plant nursery and storage system of claim 1 wherein plant growth material placed in a planting cell is placed in said planting cell along with planting media.

12. The sub-irrigation plant nursery and storage system of claim 11 wherein the planting media is soil.

13. The sub-irrigation plant nursery and storage system of claim 1 wherein the at least one planting block has a thickness between two inches to nine inches.

14. The sub-irrigation plant nursery and storage system of claim 1 wherein the planting cells have a volume in the range of eight millilitres to 3200 millilitres.

15. The sub-irrigation plant nursery and storage system of claim 1 wherein planting cells of more than one size are included in a planting block.

16. The sub-irrigation plant nursery and storage system of claim 1 wherein the container is an inground water reservoir.

17. The sub-irrigation plant nursery and storage system of claim 1 wherein the container is a manufactured container.

18. The sub-irrigation plant nursery and storage system of claim 16 wherein the container is portable.

19. The sub-irrigation plant nursery and storage system of claim 16 wherein the container is permanently installed.

20. The sub-irrigation plant nursery and storage system of claim 1 wherein the plant material is selected from the group of trees, shrubs, forbs, perennials, vegetables and grass.

21. The sub-irrigation plant nursery and storage system of claim 1 wherein more than one field-ready plant is grown within a planting cell.

22. The sub-irrigation plant nursery and storage system of claim 1 wherein the field-ready plants once grown within planting cells are stored and irrigated within the planting blocks until the transplanting of said plants to the field is desired.
